(19) United States
(12) Patent Application Publication
(10) Pub. No.: US 2011/0302416 A1
(43) Pub. Date: Dec. 8, 2011

(54) METHOD AND SYSTEM FOR SECURED COMMUNICATION IN A NON-CTMS ENVIRONMENT

(75) Inventors: Amotz HOSHEN, Tel Aviv (IL); Alon SHAFRIR, Kfar Saba (IL); Mohan GUNDU, Shrewsbury, MA (US)

(73) Assignee: Bigband Networks Inc., Redwood City, CA (US)

(21) Appl. No.: 13/046,746

(22) Filed: Mar. 13, 2011

Related U.S. Application Data
(60) Provisional application No. 61/313,812, filed on Mar. 15, 2010.

(51) Int. Cl. H04L 9/00

(52) U.S. Cl. 713/168

(57) ABSTRACT

A method for bypassing a Cable Modem Termination System (CMTS), the method includes: receiving, by a session manager, an encrypted Security Association Identifier (SAID) and an encrypted Traffic Encryption Key (TEK) that are associated with unicast transmission from the CMTS to a cable modem. The encrypted SAID and the encrypted TEK are upstream transmitted from the cable modem. Providing to an edge device, over a secured link a representation of the SAID and a representation of the TEK. Receiving by the edge device information that is associated with the SAID and should be downstream transmitted to the cable modem. Encrypting, by the edge device, the information by the TEK to provide encrypted information. Transmitting, by the edge device, the encrypted information to the cable modem while bypassing the CMTS.

### RELATED APPLICATION

This application claims priority from U.S. provisional patent Ser. No. 61/313812, filing date Mar. 15, 2010 which is incorporated herein by reference.

### BACKGROUND OF THE INVENTION

The Data Over Cable Service Interface Specification (DOCSIS) protocol includes a Media Access Control (MAC) layer security services in its Baseline Privacy Interface (BPI+) specifications. The BPI+ allows the cable modem and the Cable Modem Termination System (CMTS) to exchange information in a secured manner. The BPI+ will also prevent unauthorized users from gaining access to the network's RF (Radio Frequency) MAC (Media Access Control) services by authenticating the cable modem by the CMTS. Various versions of DOCSIS apply different encryption schemes. For example—DOCSIS 1.1 & 2.0 defines a 56-bit Data Encryption Standard (DES) encryption while DOCSIS 3.0 defines a 128-bit Advanced Encryption Standard (AES) encryption.

According to the BPI+ protocol the CMTS will: (a) authenticate a cable modem using a unique certificate; (b) generate an Authentication Key (AK) that is shared between the cable modem and the CMTS; (c) generate a Traffic Encryption Key (TEK); (d) encrypt the TEK by the AK and send the encrypted TEK to the cable modem. The CMTS may update the AK and the TEK. The AK is updated one a week while a TEK is updated once or twice a day.

When the CMTS wishes to start a session with the cable modem it sends a Security Association Identifier (SAID) to the cable modem, the SAID points to a Security Association (SA) that includes information about the encryption used during that session. The Security Association may include the TEK and a type of encryption (for example—DES or AES).

Using a dedicated TEK per cable modem and a dedicated SAID for a session assists in controlling access to the information that is downstream transmitted (unicast, multicast or broadcast) from the CMTS to the cable modems. The TEK and SAID allows all cable modems in same MAC Domain Cable Modem Service Group (MD-CM-SG) to share the same downstream and upstream channels.

In particular, information from the Internet that is transferred to a cable modem, is sent via the CMTS, and is encrypted as described above.

The reasoning for securing the data over a cable network remains the same, also in case that CMTS is bypassed—in other words, when data is sent to the cable modem not through the CMTS—but by a different transmitting device.

There is a growing need to data security and user privacy to MSOs that wish to bypass CMTS when transmitting data to their subscribers, without changing CMTS's security mechanisms.

### SUMMARY

According to an embodiment of the invention a method for bypassing a Cable Modem Termination System (CMTS) is provided. The method may include: receiving, by a session manager, an encrypted Traffic Encryption Key (TEK) that is associated with a cable modem and an encrypted Security Association Identifier (SAID) associated with a session to be transmitted to the cable modem; wherein the encrypted SAID and the encrypted TEK are upstream transmitted from the cable modem; wherein the encrypted SAID is generated by encrypting a SAID and the encrypted TEK is generated by encrypting a TEK; providing to an edge device, over a secured link a representation of the SAID and a representation of the TEK; receiving by the edge device information that is associated with the SAID and should be downstream transmitted to the cable modem; encrypting, by the edge device, the information by the TEK to provide encrypted information; identifying the information to be transmitted to the cable modem by the SAID; and transmitting, by the edge device, the encrypted information and the SAID to the cable modem while bypassing the CMTS.

The method may include determining, by the session manager, a session to be used for transmitting the encrypted information to the cable modem; transmitting to the edge device session information about the session; and transmitting, by the edge device, the encrypted information over the session.

The method may include upstream transmitting the encrypted SAID and the encrypted TEK from the cable modem to the CMTS; and receiving the encrypted SAID and the encrypted TEK by the session manager from the CMTS.

The method may include decrypting the encrypted SAID and TEK by the session manager; encrypting the SAID and TEK by the session manager by an encryption scheme shared between the edge device and the session manager to provide the representation of the SAID and the representation of the TEK.

The method may include transmitting other information to the cable modem through the CMTS.

The encrypted information may be DOCSIS formatted.

According to an embodiment of the invention a system for bypassing a Cable Modem Termination System (CMTS) is provided. The system may include a session manager and a edge device. The session manager is coupled to the CMTS, and may be arranged to: receive an encrypted Traffic Encryption Key (TEK) that is associated with a cable modem and an encrypted Security Association Identifier (SAID) associated with a session to be transmitted to the cable modem; wherein the encrypted SAID and the encrypted TEK are upstream transmitted from the cable modem; wherein the encrypted SAID is generated by encrypting a SAID and the encrypted TEK is generated by encrypting a TEK; provide, to an edge device, over a secured link a representation of the SAID and a representation of the TEK;. The edge device may be arranged to: receive information that is associated with the SAID and should be downstream transmitted to the cable modem; encrypt the information by the TEK to provide encrypted information; identify the information to be transmitted to the cable modem by the SAID; and transmit the SAID and the encrypted information to the cable modem while bypassing the CMTS.

The session manager may be arranged to determine, a session to be used for transmitting the encrypted information to the cable modem and to transmit to the edge device session information about the session; and the edge device may be arranged to transmit the encrypted information over the session.

The session manager may be arranged to receive the encrypted SAID and the encrypted TEK from the CMTS after the encrypted SAID and the encrypted TEK are upstream transmitted to the CMTS from the cable modem.

The session manager may be arranged to decrypt the encrypted SAID and the encrypted TEK to provide the SAID and the TEK; and to encrypt the SAID and TEK by the session manager by an encryption scheme shared between the edge device and the session manager to provide the representation of the SAID and the representation of the TEK.

The edge device may be arranged to transmit the encrypted information in a DOCSIS compliant format.

According to an embodiment of the invention a method for bypassing a Cable Modem Termination System (CMTS) is provided. The method may include generating, by at least one out of an edge device and a session manager, a bypass Security Association Identifier (SAID) and a bypass Traffic Encryption Key (TEK) regardless of CMTS SAIDs and CMTS TEKs generated by the CMTS; if generating the bypass SAID and the bypass TEK by the session manager then encrypting, by the session manager, the bypass TEK and the bypass SAID to provide an encrypted bypass TEK and an encrypted bypass SAID and transmitting the encrypted bypass TEK and the encrypted bypass SAID to the edge device; encrypting the bypass TEK for decryption by the intended cable modem only and transmitting the encrypted bypass TEK and the associated SAID to the cable modem; receiving by the edge device information that should be downstream transmitted to the cable modem; encrypting, by the edge device, the information by the bypass TEK to provide encrypted information; identifying the information to be transmitted to the cable modem by the bypass SAID; and transmitting, by the edge device, the encrypted information to the cable modem at a frequency that differs from a frequency of CMTS transmissions to the cable modem, while bypassing the CMTS.

The method may include transmitting to the cable modem a bypass identifier, indicating that the bypass TEK and bypass SAID transmitted to the cable modem by the edge device were generated by the session manager.

The method may include receiving from a cable modem a collision indication about a CMTS SAID that equals the bypass SAID; changing a value of the bypass SAID to provide a new bypass SAID; and transmitting the information to the cable modem while identifying the information by the new bypass SAID.

The method may include receiving from a cable modem a collision indication about a CMTS TEK that equals the bypass TEK; changing a value of the bypass TEK to provide a new bypass TEK; and transmitting the information to the cable modem while using the new bypass TEK.

The encrypted information may be DOCSIS formatted.

According to an embodiment of the invention a system for bypassing a Cable Modem Termination System (CMTS) is provided. The system may include a session manager and an edge device; wherein at least one of the session manager and the edge device may be arranged to generate a bypass Security Association Identifier (SAID) and a bypass Traffic Encryption Key (TEK) regardless of CMTS SAIDs and CMTS TEKs generated by the CMTS; wherein the session manager may be arranged to, if the bypass SAID and the bypass TEK are generated by the session manager, to encrypt the bypass TEK and the bypass SAID to provide an encrypted bypass TEK and an encrypted bypass SAID and to transmit the encrypted bypass TEK and the encrypted bypass SAID to the edge device; wherein the edge device may be arranged to: transmit the encrypted bypass SAID and the encrypted bypass TEK to the cable modem; receive information that should be downstream transmitted to the cable modem; encrypt the information by the bypass TEK to provide encrypted information; identify the information to be transmitted to the cable modem by the bypass SAID; and transmit the encrypted information to the cable modem at a frequency that differs from a frequency of CMTS transmissions to the cable modem, while bypassing the CMTS.

The edge device may be arranged to transmit to the cable modem a bypass identifier indicating that the bypass TEK and bypass SAID transmitted to the cable modem by the edge device were generated by the session manager.

The session manager may be arranged to receive a collision indication about a CMTS SAID that equals the bypass SAID; change a value of the bypass SAID to provide a new bypass SAID; and transmit the information to the cable modem while using the new bypass SAID.

The session manager may be arranged to receive a collision indication about a CMTS TEK that equals the bypass TEK; change a value of the bypass TEK to provide a new bypass TEK; and transmit the information to the cable modem while using the new bypass TEK.

According to an embodiment of the invention a computer program product can be provided and may include a non-tangible computer readable medium that stores instructions for: generating, by at least one out of an edge device and a session manager, a bypass Security Association Identifier (SAID) and a bypass Traffic Encryption Key (TEK) regardless of CMTS SAIDs and CMTS TEKs generated by the CMTS; if generating the bypass SAID and the bypass TEK by the session manager then encrypting, by the session manager, the bypass TEK and the bypass SAID to provide an encrypted bypass TEK and an encrypted bypass SAID and transmitting the encrypted bypass TEK and the encrypted bypass SAID to the edge device; encrypting the bypass TEK for decryption by the intended cable modem only and transmitting the encrypted bypass SAID and the encrypted bypass TEK to the cable modem; receiving by the edge device information that should be downstream transmitted to the cable modem; encrypting, by the edge device, the information by the bypass TEK to provide encrypted information; identifying the information to be transmitted to the cable modem by the bypass SAID; and transmitting, by the edge device, the encrypted information to the cable modem at a frequency that differs from a frequency of CMTS transmissions to the cable modem, while bypassing the CMTS.

According to an embodiment of the invention a computer program product may be provided and may include a non-tangible computer readable medium that stores instructions for: receiving an encrypted Traffic Encryption Key (TEK) that is associated with a cable modem and an encrypted Security Association Identifier (SAID) associated with a session to be transmitted to the cable modem; wherein the encrypted SAID and the encrypted TEK are upstream transmitted from the cable modem; wherein the encrypted SAID is generated by encrypting a SAID and the encrypted TEK is generated by encrypting a TEK; providing to an edge device, over a secured link a representation of the SAID and a representation of the TEK; receiving by the edge device information that is associated with the SAID and should be downstream transmitted to the cable modem; encrypting, by the edge device, the information by the TEK to provide encrypted information; identifying the information to be transmitted to the cable modem by the SAID; and transmitting, by the edge device, the encrypted information and the SAID to the cable modem while bypassing the CMTS.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a system and signals exchanges between components according to an embodiment of the invention;

FIG. 2 illustrates a system and signals exchanges between components according to an embodiment of the invention;

FIG. 3 illustrates a system and signals exchanges between components according to an embodiment of the invention;

FIG. 4 illustrates a method according to an embodiment of the invention; and

FIG. 5 illustrates a method according to an embodiment of the invention; and

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Glossary

CM—Cable Modem. A type of modem that provides access to a data signal sent over cable television (TV) infrastructure.

CMTS—Cable Modem Termination System. CMTS is equipment typically found in a cable operator's head-end or hub site. It is used to provide high speed data services, such as cable internet or Voice over IP, to cable subscribers.

SA—Security Association. The encryption related information for session may be arranged in an entity called DOCSIS SA.

SAID—SA identifier. It is unique per SA in MD-DS-SG.

TEK—Traffic Encryption Key. It is used to encrypt the data between CMTS and the cable modem.

ED—Edge Device. Transmitting equipment, usually found at the hub site of cable operator, transmits data signal over RF channels.

SM—Session Manager. A network entity that can communicate with Edge Devices and Cable Modems, and manages the delivery of sessions to end users.

The requirements for securing the data that is forwarded to the cable modem are providing acceptable data privacy while the cable modems should be able to decrypt the data.

The encryption and decryption processes may use a Traffic Encryption Key (TEK). The TEK is used to encrypt the data between CMTS and the cable modem.

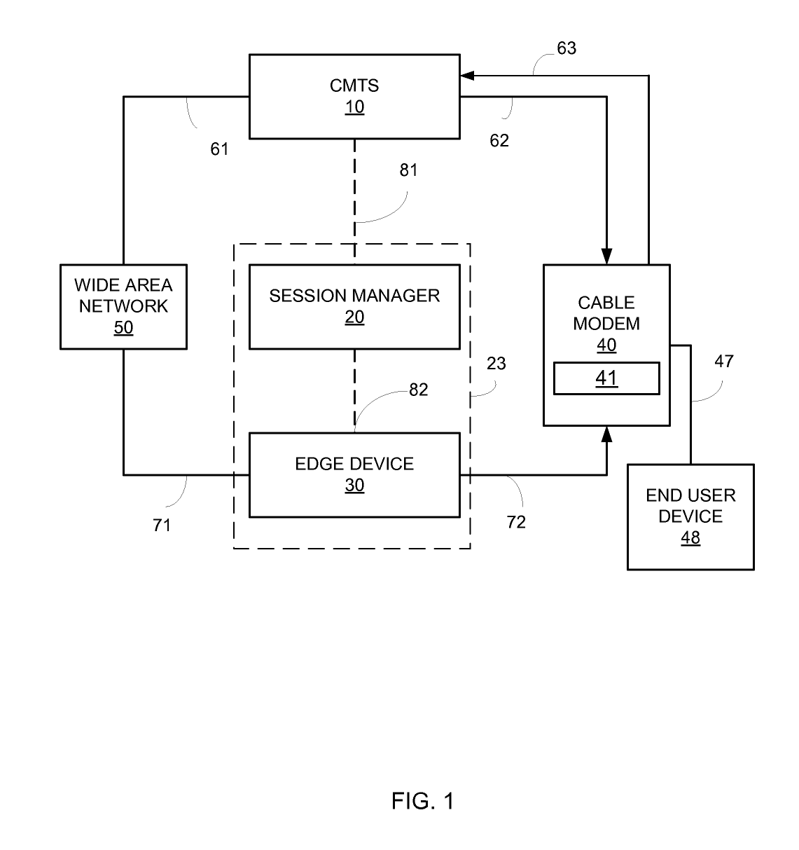

FIG. 1 illustrates system 23 and its environment according to an embodiment of the invention. System 23 includes session manager 20 and edge device 30 that are coupled to each other via secure link 82. The edge device 30 can receive information (over link 71) from a wide area network 50 such as the Internet or a private (or partially private network) and can provide encrypted information to cable modem 40 over link 72.

It is noted that each link can represent one or more communication channels. It is noted that the session manager 20 and the edge device can be integrated, can be proximate to each other or spaced apart from each other.

The CMTS 10 is connected to system 23 via link 81, to the wide area network 50 via link 61 and to cable modem 40 via upstream link 63 and downstream link 62.

The cable modem 40 is also connected to an end user device (such as a television, a computer and the like) 48 via link 47.

It is noted that the CMTS 10 and the system 23 can be connected to multiple cable modems and that FIG. 1 illustrates a single cable modem 40 for simplicity of explanation. It is noted that the cable modem 40 can host a cable modem client 41.

Using TEK and SAID generated by the CMTS

According to an embodiment of the invention the edge device 30 may receive TEKs that were generated by the CMTS 10, use them to encrypt data, and transmit the encrypted data over a link 72 (in a DOCSIS compliant manner) towards the cable modem 40 while bypassing the CMTS. The CMTS 10 does not provide the TEK to the edge device 30 and the edge device 30 obtains the TEK and SAID from the cable modem 40 (via the session manager 20).

According to an embodiment of the invention, the edge device 30 will use the same TEK and SAID as the CMTS does, in the encryption process.

A cable modem client 41 can be installed on the cable modem 40 and it has the ability to access the TEK associated with a cable modem 40 and a Security Association Identifier (SAID) associated with a session that is opened with the cable modem 40.

In addition, the cable modem client 41 and the session manager 20 have the ability to communicate with each other in a secured pre-defined way (for example by a public/private key mechanism). The establishment of the secured communication and the exchange of information can utilize links 62, 63, 72 and 81—links 62 and 63 between the cable modem 40 and the CMTS 10, link 81 between the CMTS 10 and the session manager 20 and a link 72 between the edge device 30 and the cable modem 40.

The session manager and the edge device have the ability to communicate with each other in a secured way (e.g. messages are encrypted with secret keys, are shared among the session manager and the edge device).

According to an embodiment of the invention, there could be a trigger to initiate the process of a new session to be delivered through the session manager 20 which bypasses the CMTS 10. For example, the cable modem client 41 can identify that a new session is requested by the end user, and deliver that request to the session manager 20. It is noted that other entities can provide such a trigger—especially when there is a need to downstream data to the cable modem. It is also noted that the session can be initiated automatically whenever the cable modem is activated and that same session can be used for all traffic to that cable modem that is bypassing the CMTS.

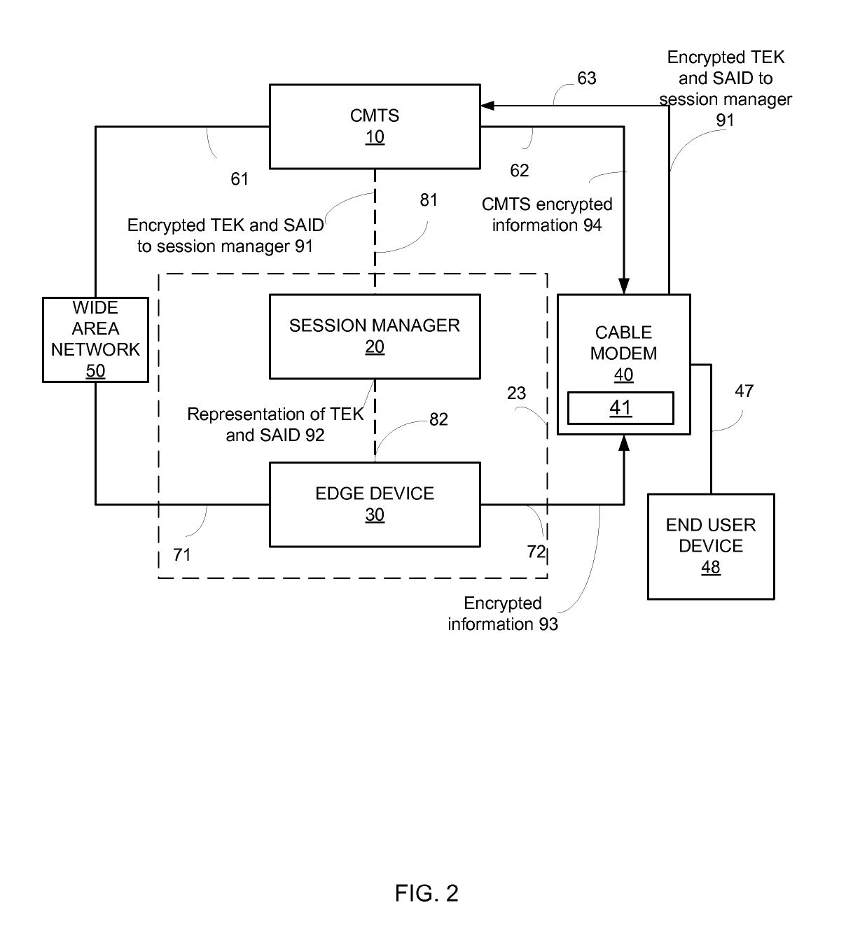

When a session is to be delivered towards the cable modem 40 via the session manager 20, the following occurs:
i. The cable modem client 41 will communicate the TEK (which is used by the cable modem 40 when communicating with the CMTS 10) to the session manager 20. This may include getting the TEK used for a unicast downstream link assigned by the CMTS 10 to this the cable modem 40 with its corresponding SAID;
ii. The cable modem 40 will encrypt the TEK in a pre-defined way that is known to the cable modem 40 and the session manager 20, to be sent towards the session manager 20 along with the SAID; TEK will be encrypted such that other cable modems cannot decrypt it; and
iii. Send, by the cable modem 40, the encrypted information as a message that is addressed to the session manager 20, via a CMTS uplink 63. Referring to FIG. 2, this is denoted “Encrypted TEK and SAID to session manager 91”. The CMTS 10 will transmit this to the session manager 20—as illustrated by “Encrypted TEK and SAID to session manager 91”.

The session manager 20 will:
i. Pass the representation of the TEK and SAID to the relevant the edge device 30 (“representation of TEK and SAID 92”). If there are more than one edge device then the session manager 20 can determine the relevant edge device;
ii. Allocate a session on the edge device 30, to deliver relevant information (for example, a session could be associated with a specific internet video stream). The session defines data characteristics (e.g. IP address) to be passed on session and a physical link accessible to be used; and
iii. Associate the SAID with a session delivering data towards the cable modem 40, and
iv. Communicate the association to the edge device 30.

It is noted that if the edge device 30 can decrypt the encrypted SAID and TEK that are sent from the cable modem 40 then the session manager 20 may pass them “as is” to the edge device 30 or may perform a decryption and an encryption of the encrypted SAID and TEK. If the edge device 30 cannot perform that decryption (for example—it is not provided with the Authentication Key shared between the CMTS and the cable device) then the session manager 20 shall decrypt the encrypted SAID and TEK and the encrypt them in a manner that can be reversed by the edge device 30—so that the edge device 30 can decrypt the newly encrypted SAID and TEK.

In general—the session manager 20 sends to the edge device 30 a representation of the TEK and the SAID. The representation can be an encrypted version of the EDGE and SAID.

The edge device will:
i. Receive the data to be passed on the relevant session.
ii. Use the TEK to encrypt content that belong to relevant session.
iii. Mark data frames (such as DOCSIS frames) of that session with corresponding SAID.
iv. Multiplex and transmit session data over physical link 72 accessible by the relevant the cable modem 40.

The cable modem 40 will receive the encrypted session from the edge device 30 (identifying it by the SAID) and will decrypt it using the TEK it holds associated with this SAID.

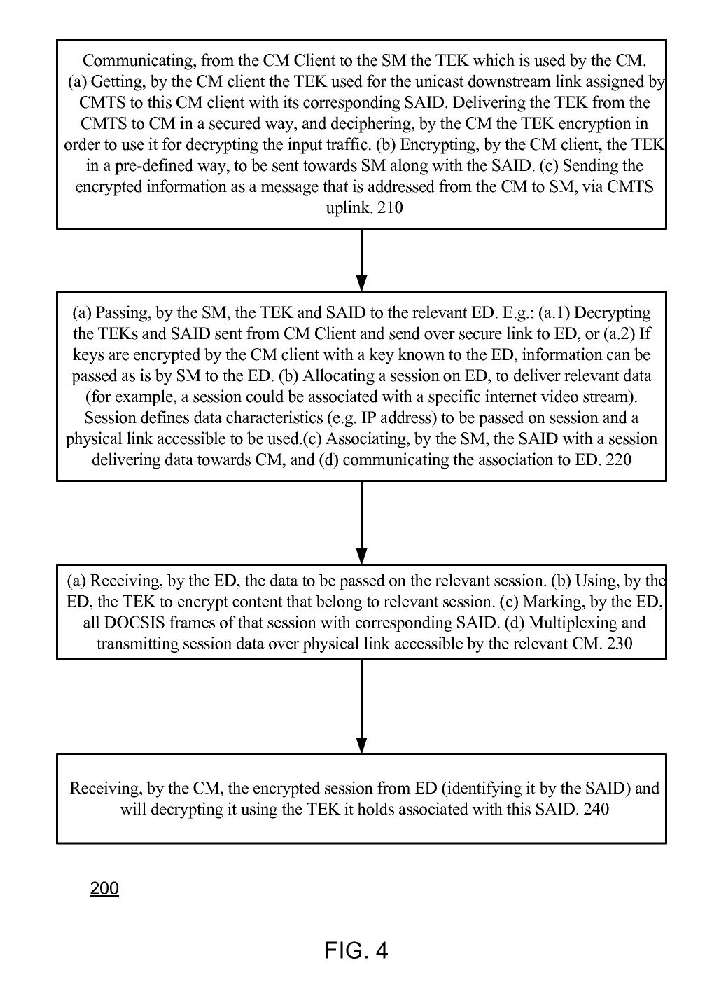

FIG. 4 illustrates method 200 according to an embodiment of the invention.

Method 200 includes stage 210, 220 and 230.

Stage 210 includes communicating, from the cable modem client to the session manager the TEK which is used by the cable modem.

Stage 210 can include:
i. Getting, by the cable modem client the TEK used for the unicast downstream link assigned by CMTS to this the cable modem client with its corresponding SAID.
ii. Delivering the TEK from the CMTS to the cable modem in a secured way,
iii. Deciphering, by the cable modem the TEK encryption in order to use it for decrypting the input traffic.
iv. Encrypting, by the cable modem client, the TEK in a pre-defined way, to be sent towards the session manager along with the SAID
v. Sending the encrypted information as a message that is addressed from the cable modem to the session manager, via CMTS uplink.

Stage 220 may include
i. Passing, by the session manager, the TEK and SAID to the relevant the edge device.
   1. Decrypting the TEKs and SAID sent from the cable modem Client and send over secure link to the edge device, or
   2. If keys are encrypted by the cable modem client with a key known to the edge device, encrypting, by the session manager, information can be passed to the edge device.
ii. Allocating a session on the edge device, to deliver relevant data (for example, a session could be associated with a specific internet video stream). Session defines data characteristics (e.g. IP address) to be passed on session and a physical link accessible to be used.
iii. Associating, by the session manager, the SAID with a session delivering data towards the cable modem, and
iv. Communicating the association to the edge device.

Stage 230 includes:
i. Receiving, by the edge device, the data to be passed on the relevant session.
ii. Using, by the edge device, the TEK to encrypt content that belongs to relevant session.
iii. Marking, by the edge device, all frames (such as DOCSIS frames) of that session with corresponding SAID.
iv. Multiplexing and transmitting session data over physical link accessible by the relevant the cable modem.

Stage 240 includes receiving, by the cable modem, the encrypted session from the edge device (identifying it by the SAID) and will decrypting it using the TEK it holds associated with this SAID.

Using TEK and SAID that were not generated by the CMTS

According to another embodiment of the invention the session manager may generate its own TEKs and use them for encrypting traffic that bypasses the CMTS 10.

According to this embodiment, a new Security Association (SA) is generated, so that the cable modem will receive from the edge device DOCSIS frames that are encrypted by a TEK that is different from CMTS's. Such a TEK is referred to as bypass TEK. A bypass SAID can be generated by the session manager 20 or the edge device 30 and may generated regardless the TEKs and SAIDs generated by the CMTS. The latter can be referred to as CMTS TEKs and CMTS SAIDs.

The bypass information may include packets that are marked with a different, additional SAID (bypass SAID) and will be used on unique SAID will be set accordingly

The session manager will negotiate the SA with the cable modem Client, and provide the TEKs (bypass TEKs) to the edge device upon session setup.

The negotiation could be made by several options:
i. BPI+ over IP: the cable modem client and the session manager will be able to communicate using BPI+ protocol. Messages could be delivered over IP. In this method, the cable modem will maintain two authentication keys—one for communication of CMTS TEKs, and the other for communication of the bypass TEKs.
ii. Non BPI+: use well-known key-exchange protocol, for example IKE or SSL, in order to communicate the encryption keys.

In both cases, the session manager 20 doesn't need to authenticate the cable modem 40, since the cable modem 40 will be authorized to send messages reaching the session manager 20 only after being already authenticated by CMTS 10.

It may be desirable to prevent both CMTS 10 and the session manager 20 from setting the same SAID for different SAs. Thus—the bypass SAID should differ from the CMTS SAIDs.

This can prevented by one of the following stages:
i. Associating an SA with combination of SAID and a set of physical link (e.g. edge device frequency channel). Since CMTS and the edge device don't use same physical link this prevents ambiguities. Thus—the combination of a bypass SAID and a physical link identifier used for bypass traffic may differ from a combination of a CMTS SAID and a physical link identifier used for CMTS traffic. Thus—differences in the frequencies of transmissions can assist in differentiating between transmissions.
ii. Using additional identifiers for identifying bypass traffic—for example using additional tags in DOCSIS frames, for example DSID, so SA used with the edge device is associated with combination of bypass or CMTS SAID and DSID.
iii. If usage allows time to recover from errors, the cable modem client 41 can detect ambiguities (CMTS SAID and bypass SAID of the same value and additionally or alternatively bypass TEK and CMTS TEK of the same value), alert the session manager 20 by sending a collision indication 97 which will initiate a corrective process to replace SAID of ambiguous sessions.

According to an embodiment of the invention, there could be a trigger to initiate the process of a new session to be delivered through the session manager 20 which bypasses the CMTS 10. For example, the cable modem client 41 can identify that a new session is requested by the end user, and deliver that request to the session manager 20. It is noted that other entities can provide such a trigger—especially when there is a need to downstream data to the cable modem. It is also noted that the session can be initiated automatically whenever the cable modem is activated and that same session can be used for all traffic to that cable modem that is bypassing the CMTS.

When a session is to be delivered towards the cable modem 40 via the session manager 20, the following process will take place:

The session manager will:
i. Generate a new SA, independent of those generated by the CMTS 10, and set a corresponding bypass SAID.
ii. Obtain TEKs for that SA that are known to the edge device 30.
   1. Generate bypass TEKs and send them to the edge device 30 over secure link, or
   2. Ask the edge device 30 to generate bypass TEKs, encrypt them and send it to the session manager 20.
iii. Associate session with SA and data properties to be delivered (e.g. IP address).
iv. Send SA information (bypass SAID and bypass TEK) to the cable modem 40 using the secure negotiation protocol.

The edge device 30 will:
i. Receive data to be delivered over the session.
ii. Use the bypass TEK to encrypt content that belong to relevant session.
iii. Mark all frames (such as DOCSIS frames) of that session with corresponding bypass SAID.
iv. Multiplex and transmit session data over physical link accessible by the relevant the cable modem.

The cable modem 40 will:
i. Get the bypass TEKs from the edge device and decipher them in order to use them by the secure negotiation protocol.
ii. Receive the encrypted session from the edge device;
iii. Identify the session by the bypass SAID; and
iv. Decrypt the encrypted data using the bypass TEK it had received associated with this bypass SAID.

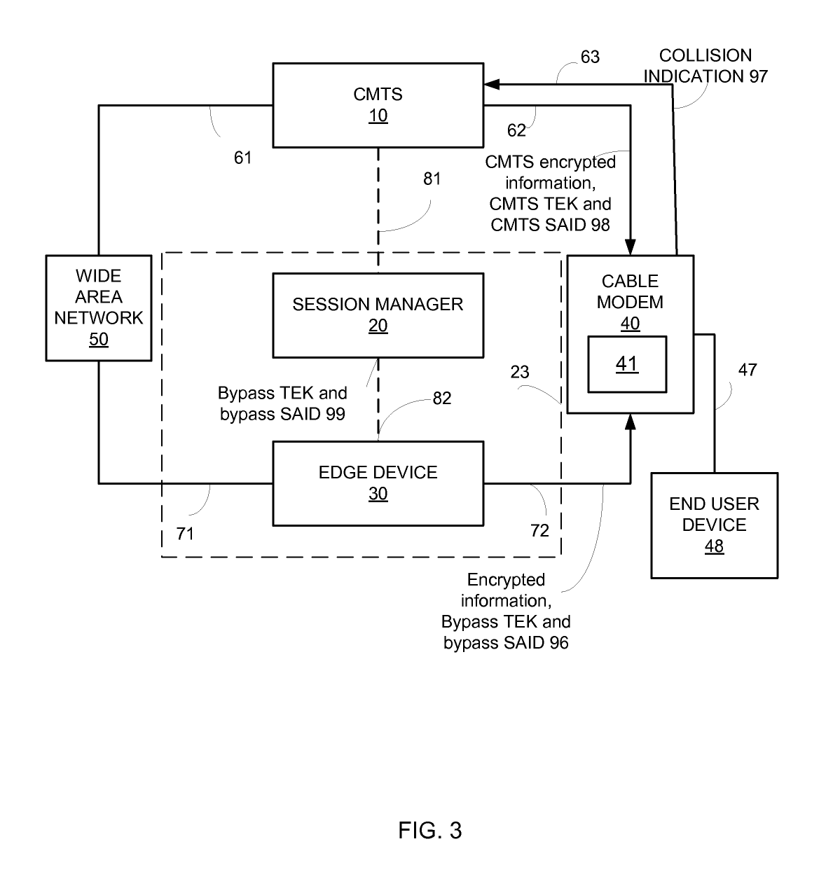

FIG. 3 illustrates various signals exchanged between the mentioned above entities: (a) Collision indicator 97 sent from the cable modem 40 through the CMTS 10 to the session manager 20; (b) CMTS encrypted information, CMTS TAK and CMTS SAID 98 sent from the CMTS 10 to cable modem 40; (c) bypass TEK and bypass SAID 99 exchanged between the session manager 20 and the edge device 30; and (d) encrypted information, bypass TEK and bypass SAID 96 sent from the edge device 30 the cable modem 40.

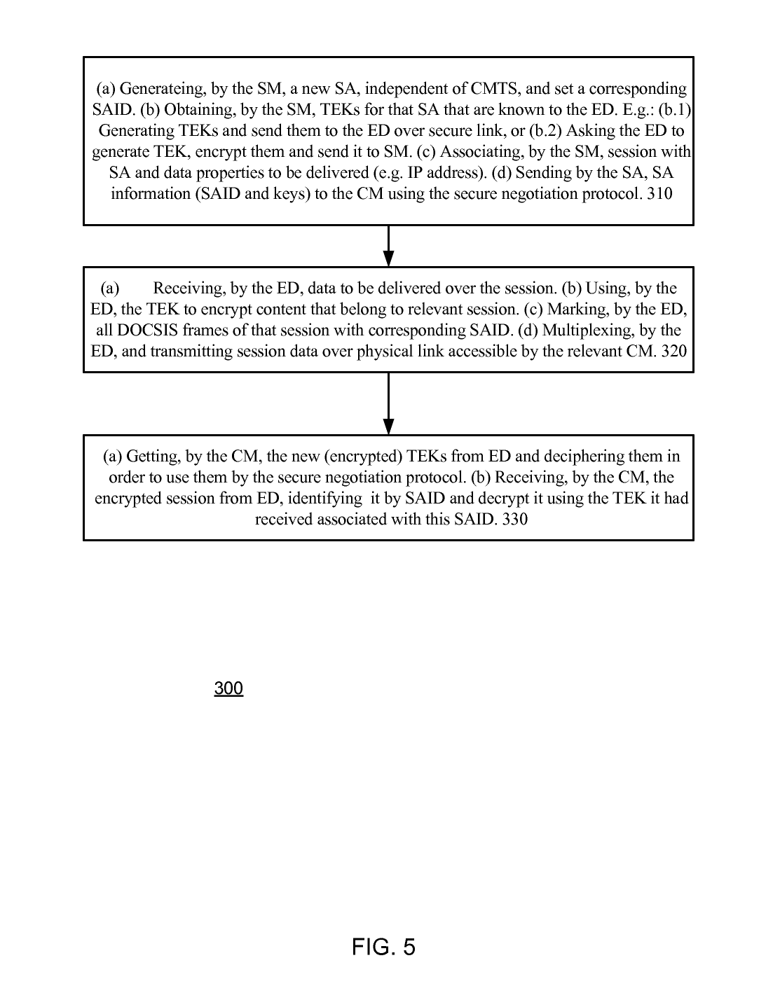

FIG. 5 illustrates method 300 according to an embodiment of the invention.

Method 300 includes stages 310, 320, 330 and 340.

Stage 310 may include:
i. Generating, by the session manager, a new SA, independent of CMTS, and set a corresponding SAID.
ii. Obtaining, by the session manager, bypass TEKs for that SA that are known to the edge device.
   1. Generating bypass TEKs and send them to the edge device over secure link, or
   2. Asking the edge device to generate bypass TEKs, encrypt them and send it to the session manager.
iii. Associating, by the session manager, session with SA and data properties to be delivered (e.g. IP address).
iv. Sending by the SA, SA information (SAID and keys) to the cable modem using the secure negotiation protocol.

Stage 320 may include:
i. Receiving, by the edge device, data to be delivered over the session. The edge device can receive, for example, IP packets and it can identify by the IP address which CM they belong to.
ii. Using, by the edge device, the bypass TEK to encrypt content that belong to relevant session.
iii. Marking, by the edge device, all frames (such as DOCSIS frames) of that session with corresponding bypass SAID. This marking provides an identifying of the information to be transmitted to the cable modem by the SAID.
iv. Multiplexing, by the edge device, and transmitting session data over physical link accessible by the relevant the cable modem .

Stage 330 may include:
i. Getting, by the cable modem, the bypass TEKs from the edge device and deciphering them in order to use them by the secure negotiation protocol.
ii. Receiving, by the cable modem, the encrypted session from the edge device, identifying it by the bypass SAID and decrypt it using the bypass TEK it had received associated with this bypass SAID.

The mentioned above methods and systems can: (i) allow the MSOs to have additional links, other than CMTS's links, to deliver data towards Cable Modems. (ii) provide data protection and thereby allow the MSO, when deploying such additional links, not to compromise on data security and user privacy.

The mentioned above methods and systems do not require any integration with CMTS's core.

A computer program product is provided and may include a non-transitory computer readable medium. It stores instructions that can be read by a computer and cause the computer to execute any of the mentioned above methods. The computer can be a part of the session manager, or the edge device or both. A portion of the instructions may be executed by the session manager and a portion can be executed by the edge device. The non-transitory computer readable medium can include multiple memory units, and the like. The computer readable medium can be a physical entity such as a storage module, a memory device, a disk, a diskette, and the like. The non-transitory computer readable medium can store instructions to any of the mentioned above methods, to any combination of the mentioned above methods or to any of the mentioned above method stages.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for bypassing a Cable Modem Termination System (CMTS), the method comprises:
receiving, by a session manager, an encrypted Traffic Encryption Key (TEK) that is associated with a cable modem and an encrypted Security Association Identifier (SAID) associated with a session to be transmitted to the cable modem; wherein the encrypted SAID and the encrypted TEK are upstream transmitted from the cable modem; wherein the encrypted SAID is generated by encrypting a SAID and the encrypted TEK is generated by encrypting a TEK;
providing to an edge device, over a secured link a representation of the SAID and a representation of the TEK;
receiving by the edge device information that is associated with the SAID and should be downstream transmitted to the cable modem;
encrypting, by the edge device, the information by the TEK to provide encrypted information;
identifying the information to be transmitted to the cable modem by the SAID; and
transmitting, by the edge device, the encrypted information and the SAID to the cable modem while bypassing the CMTS.

2. The method according to claim 1, comprising:
determining, by the session manager, a session to be used for transmitting the encrypted information to the cable modem;
transmitting to the edge device session information about the session; and
transmitting, by the edge device, the encrypted information over the session.

3. The method according to claim 1, comprising:
upstream transmitting the encrypted SAID and the encrypted TEK from the cable modem to the CMTS; and
receiving the encrypted SAID and the encrypted TEK by the session manager from the CMTS.

4. The method according to claim 1, comprising:
decrypting the encrypted SAID and TEK by the session manager;
encrypting the SAID and TEK by the session manager by an encryption scheme shared between the edge device and the session manager to provide the representation of the SAID and the representation of the TEK.

5. The method according to claim 1 further comprising transmitting other information to the cable modem through the CMTS.

6. The method according to claim 1, wherein the encrypted information is DOCSIS formatted.

7. A system for bypassing a Cable Modem Termination System (CMTS), the system comprises a session manager and a edge device;
wherein the session manager is coupled to the CMTS, and is arranged to:
receive an encrypted Traffic Encryption Key (TEK) that is associated with a cable modem and an encrypted Security Association Identifier (SAID) associated with a session to be transmitted to the cable modem; wherein the encrypted SAID and the encrypted TEK are upstream transmitted from the cable modem; wherein the encrypted SAID is generated by encrypting a SAID and the encrypted TEK is generated by encrypting a TEK;
provide, to an edge device, over a secured link a representation of the SAID and a representation of the TEK;
wherein the edge device is arranged to:
receive information that is associated with the SAID and should be downstream transmitted to the cable modem;
encrypt the information by the TEK to provide encrypted information;
identify the information to be transmitted to the cable modem by the SAID; and
transmit the SAID and the encrypted information to the cable modem while bypassing the CMTS.

8. The system according to claim 7, wherein the session manager is arranged to determine, a session to be used for transmitting the encrypted information to the cable modem and to transmit to the edge device session information about the session; and
wherein the edge device is arranged to transmit the encrypted information over the session.

9. The system according to claim 7, wherein the session manager is arranged to receive the encrypted SAID and the encrypted TEK from the CMTS after the encrypted SAID and the encrypted TEK are upstream transmitted to the CMTS from the cable modem.

10. The system according to claim 7, wherein the session manager is arranged to decrypt the encrypted SAID and the encrypted TEK to provide the SAID and the TEK; and to encrypt the SAID and TEK by the session manager by an encryption scheme shared between the edge device and the session manager to provide the representation of the SAID and the representation of the TEK.

11. The system according to claim 7, wherein the edge device is arranged to transmit the encrypted information in a DOCSIS compliant format.

12. A method for bypassing a Cable Modem Termination System (CMTS), the method comprises:
generating, by at least one out of an edge device and a session manager, a bypass Security Association Identifier (SAID) and a bypass Traffic Encryption Key (TEK) regardless of CMTS SAIDs and CMTS TEKs generated by the CMTS;
if generating the bypass SAID and the bypass TEK by the session manager then encrypting, by the session manager, the bypass TEK and the bypass SAID to provide an encrypted bypass TEK and an encrypted bypass SAID and transmitting the encrypted bypass TEK and the encrypted bypass SAID to the edge device;
Encrypting the bypass TEK for decryption by the intended cable modem only and transmitting the encrypted bypass TEK and the associated SAID to the cable modem;
receiving by the edge device information that should be downstream transmitted to the cable modem;
encrypting, by the edge device, the information by the bypass TEK to provide encrypted information;
identify the information to be transmitted to the cable modem by the bypass SAID;
and
transmitting, by the edge device, the encrypted information to the cable modem at a frequency that differs from a frequency of CMTS transmissions to the cable modem, while bypassing the CMTS.

13. The method according to claim 12, comprising transmitting to the cable modem a bypass identifier, indicating that the bypass TEK and bypass SAID transmitted to the cable modem by the edge device were generated by the session manager.

14. The method according to claim 12, comprising:
receiving from a cable modem a collision indication about a CMTS SAID that equals the bypass SAID;
changing a value of the bypass SAID to provide a new bypass SAID; and
transmitting the information to the cable modem while identifying the information by the new bypass SAID.

15. The method according to claim 12, comprising:
receiving from a cable modem a collision indication about a CMTS TEK that equals the bypass TEK;
changing a value of the bypass TEK to provide a new bypass TEK; and
transmitting the information to the cable modem while using the new bypass TEK.

16. The method according to claim 12, wherein the encrypted information is DOCSIS formatted.

17. A system for bypassing a Cable Modem Termination System (CMTS), the system comprises a session manager and an edge device;
wherein at least one of the session manager and the edge device is arranged to generate a bypass Security Association Identifier (SAID) and a bypass Traffic Encryption Key (TEK) regardless of CMTS SAIDs and CMTS TEKs generated by the CMTS;
wherein the session manager is arranged to, if the bypass SAID and the bypass TEK are generated by the session manager, to encrypt the bypass TEK and the bypass SAID to provide an encrypted bypass TEK and an encrypted bypass SAID and to transmit the encrypted bypass TEK and the encrypted bypass SAID to the edge device;
wherein the edge device is arranged to:
transmit the encrypted bypass SAID and the encrypted bypass TEK to the cable modem;
receive information that should be downstream transmitted to the cable modem;
encrypt the information by the bypass TEK to provide encrypted information;
identify the information to be transmitted to the cable modem by the bypass SAID; and
transmit the encrypted information to the cable modem at a frequency that differs from a frequency of CMTS transmissions to the cable modem, while bypassing the CMTS.

18. The system according to claim 17, wherein the edge device is arranged to transmit to the cable modem a bypass identifier indicating that the bypass TEK and bypass SAID transmitted to the cable modem by the edge device were generated by the session manager.

19. The system according to claim 17, wherein the session manager is arranged to receive a collision indication about a CMTS SAID that equals the bypass SAID; change a value of the bypass SAID to provide a new bypass SAID; and transmit the information to the cable modem while using the new bypass SAID.

20. The system according to claim 17, wherein the session manager is arranged to receive a collision indication about a CMTS TEK that equals the bypass TEK; change a value of the bypass TEK to provide a new bypass TEK; and transmit the information to the cable modem while using the new bypass TEK.

21. A computer program product comprising a non-tangible computer readable medium that stores instructions for:
generating, by at least one out of an edge device and a session manager, a bypass Security Association Identifier (SAID) and a bypass Traffic Encryption Key (TEK) regardless of CMTS SAIDs and CMTS TEKs generated by the CMTS;
if generating the bypass SAID and the bypass TEK by the session manager then encrypting, by the session manager, the bypass TEK and the bypass SAID to provide an encrypted bypass TEK and an encrypted bypass SAID and transmitting the encrypted bypass TEK and the encrypted bypass SAID to the edge device;
Encrypting the bypass TEK for decryption by the intended cable modem only and transmitting the encrypted bypass SAID and the encrypted bypass TEK to the cable modem;
receiving by the edge device information that should be downstream transmitted to the cable modem;
encrypting, by the edge device, the information by the bypass TEK to provide encrypted information;
identifying the information to be transmitted to the cable modem by the bypass SAID;
and
transmitting, by the edge device, the encrypted information to the cable modem at a frequency that differs from a frequency of CMTS transmissions to the cable modem, while bypassing the CMTS.

22. A computer program product comprising a non-tangible computer readable medium that stores instructions for:
receiving an encrypted Traffic Encryption Key (TEK) that is associated with a cable modem and an encrypted Security Association Identifier (SAID) associated with a session to be transmitted to the cable modem; wherein the encrypted SAID and the encrypted TEK are upstream transmitted from the cable modem; wherein the encrypted SAID is generated by encrypting a SAID and the encrypted TEK is generated by encrypting a TEK;
providing to an edge device, over a secured link a representation of the SAID and a representation of the TEK;
receiving by the edge device information that is associated with the SAID and should be downstream transmitted to the cable modem;
encrypting, by the edge device, the information by the TEK to provide encrypted information;
identifying the information to be transmitted to the cable modem by the SAID; and
transmitting, by the edge device, the encrypted information and the SAID to the cable modem while bypassing the CMTS.
